(19) United States
(12) Patent Application Publication
(10) Pub. No.: US 2006/0072038 A1
(43) Pub. Date: Apr. 6, 2006

(54) Method and system for detecting deinterlaced moving thin diagonal lines

(76) Inventor: Richard H. Wyman, Sunnyvale, CA (US)

Correspondence Address: MCANDREWS HELD & MALLOY, LTD, 500 WEST MADISON STREET, SUITE 3400, CHICAGO, IL, 60661, US

(21) Appl. No.: 11/027,366

(22) Filed: Dec. 30, 2004

Related U.S. Application Data
(60) Provisional application No. 60/616,132, filed on Oct. 5, 2004.

(51) Int. Cl. H04N 11/20

(52) U.S. Cl. 348/448

(57) ABSTRACT

A system and method that detect edges that are near horizontal thin lines in interlaced video in a deinterlacer. The system may detect edges in a video image and determine whether the edges are diagonal or nearly horizontal edges. Based on the determination the system may select a filter appropriate for filtering the edge. The system may utilize a control signal that may be low or high, and may according disable or enable filtering nearly horizontal edges, respectively.

### RELATED APPLICATIONS

This patent application makes reference to, claims priority to and claims benefit from U.S. Provisional Patent Application Ser. No. 60/616,132, entitled “Method and System for Detecting Deinterlaced Moving Thin Diagonal Lines,” filed on Oct. 5, 2004, the complete subject matter of which is hereby incorporated herein by reference, in its entirety.

This application is related to the following applications, each of which is incorporated herein by reference in its entirety for all purposes:
U.S. patent application Ser. No. 10/945,619 (Attorney Docket No. 15444US02) filed Sep. 21, 2004;
U.S. patent application Ser. No. 10/945,796 (Attorney Docket No. 15450US02) filed Sep. 21, 2004;
U.S. patent application Ser. No. 10/946,153 (Attorney Docket No. 15631US02 filed Sep. 21, 2004; and
U.S. patent application Ser. No. 10/945,645 (Attorney Docket No. 15632US02 filed Sep. 21, 2004.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Many advanced video systems support content in progressive or interlaced format, and as a result, devices such as deinterlacers have become important components in many video systems. Deinterlacers convert video from interlaced video format into progressive video format.

Deinterlacing takes interlaced video fields and coverts them into progressive frames, at double the display rate. Certain problems may arise concerning the motion of objects from image to image. Objects that are in motion are encoded differently in interlaced fields from progressive frames. Video images, encoded in deinterlaced format, containing little motion from one image to another may be deinterlaced into progressive format with virtually no problems or visual artifacts. However, problems arise with video images containing a lot of motion and change from one image to another, when converted from interlaced to progressive format. As a result, some video systems were designed with motion adaptive deinterlacers.

Today, motion adaptive deinterlace video systems rely on multiple fields of data to extract the highest picture quality from a video signal. When motion is detected between fields, it may be very difficult to use temporal information for deinterlacing. Instead, a deinterlacing circuit must utilize a spatial filter (usually a vertical filter of the field of interest). However, often the source material has diagonal lines, or curved edges, and using a spatial filter may not yield satisfactory results. For example, diagonal or curved edges will be represented with stair-step or jaggies that are visible in the image.

One type of deinterlacer, a per-pixel motion adaptive deinterlacer, uses a measured value of motion to determine whether a temporally or spatially biased approximation is more suitable. When motion is high in a sequence of images, the spatial approximation dominates. The deinterlacer can use a diagonal filter to improve the quality of the spatial approximation. A diagonal filter filters along the direction of a localized edge, and in doing so it reduces jaggies in moving diagonal edges.

Thin, near horizontal lines present a particular difficulty for diagonal spatial filters. During interlacing and subsequent deinterlacing, thin diagonal lines can appear to break up into discreet segments. It is very hard to detect detail that is near horizontal since the width of the angled detection filter would have to be very large. FIG. 1 illustrates an exemplary near horizontal line in a field. The line 101 may be a near horizontal line in a field, and may not be detected by a deinterlacer as a diagonal edge. On limiting visibility to a small horizontal window 103, when an image is quantized into pixels and viewed close-up, near horizontal lines such as line 101 break into a collection of horizontal segments. Looking closer at a piece 103 of the line 101, the piece 103 comprises horizontal segments 105. The horizontal segments 105 are in the present lines in the fields of the interlaced content. The missing lines from the field such as lines 107 will be generated by the deinterlacer. A deinterlacer treats each of the segments 105 as a horizontal line and reproduces the line 101 as a collection of horizontal segments, which when applied to lines such as line 101 within a field look distorted and the discontinuity created by the absent lines 107 between the horizontal pieces creates artifacts visible to a viewer.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the present invention may be seen in a system and method that detect edges that are near horizontal thin lines in interlaced video in a deinterlacer. The method comprises assessing an edge in a diagonal direction; assessing the edge in a near horizontal direction; and filtering the edge in the diagonal direction or the near horizontal direction to use in deinterlacing the edge based on assessment results.

Assessing of the edge in the diagonal direction may comprise determining the angle associated with the edge and determining the strength associated with the edge. Assessing the edge in the diagonal direction may also comprise determining the direction of the edge and selecting an associated set of filter coefficients.

Assessing of the edge in the near horizontal direction may comprise determining the angle associated with the edge; determining the strength associated with the edge; and determining an adjusted strength associated with the edge. Determining the angle associated with the edge may comprise examining a set of pixels associated with the edge; determining a first subset of pixels that comprise the edge; and determining a second subset of pixels that comprise a background with respect to the edge. Assessing the edge in the near horizontal direction may also comprise determining the direction of the edge and selecting an associated set of filter coefficients.

In an embodiment of the present invention, a control signal may be utilized. Assessing the edge in the near horizontal direction may be disabled when the control signal is low, and enabled when the control signal is high.

The system comprises circuitry capable of performing the method as described hereinabove that detect edges that are near horizontal thin lines in interlaced video in a deinterlacer.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 illustrates an exemplary near horizontal line in a field.

FIG. 2A illustrates a block diagram of an exemplary directional filter, in accordance with an embodiment of the present invention.

FIG. 2B illustrates an exemplary cluster of pixels, in accordance with an embodiment of the present invention.

FIG. 3A illustrates an exemplary cluster of pixels in a near horizontal thin line in a field.

FIG. 3B illustrates an exemplary cluster of pixels in a near horizontal thin line in a field when deinterlaced appropriately to maintain continuity of the line, in accordance with an embodiment of the present invention.

FIG. 3C illustrates an exemplary result of applying a north-east filter to a near horizontal thin line, in accordance with an embodiment of the present invention.

FIG. 4 illustrates a flow diagram of an exemplary method for detecting near horizontal lines, in accordance with an embodiment of the present invention.

### DETAILED DESCRIPTION OF THE INVENTION

Aspects of the present invention relate to processing video signals. More specifically, certain embodiments of the invention relate to a method and system for implementing an improved spatial diagonal filter in a motion adaptive deinterlacer. The improved spatial diagonal filter may detect near horizontal thin lines and may filter in a specific direction to reduce the appearance of segmented lines in the deinterlaced output video. As a result, the output may be a more natural looking deinterlaced video.

An embodiment of the present invention may be utilized with a diagonal filter in a motion adaptive deinterlacer. U.S. patent application Ser. No. 10/945,619, filed Sep. 21, 2004 entitled “Method and System for Motion Adaptive Deinterlacer with Integrated Directional Filter” discloses an exemplary diagonal filter and an associated motion adaptive deinterlacer system, which is representative of the diagonal filter that may be utilized in connection with the present invention. Accordingly, U.S. patent application Ser. No. 10/945,619, filed Sep. 21, 2004 is hereby incorporated herein by reference in its entirety.

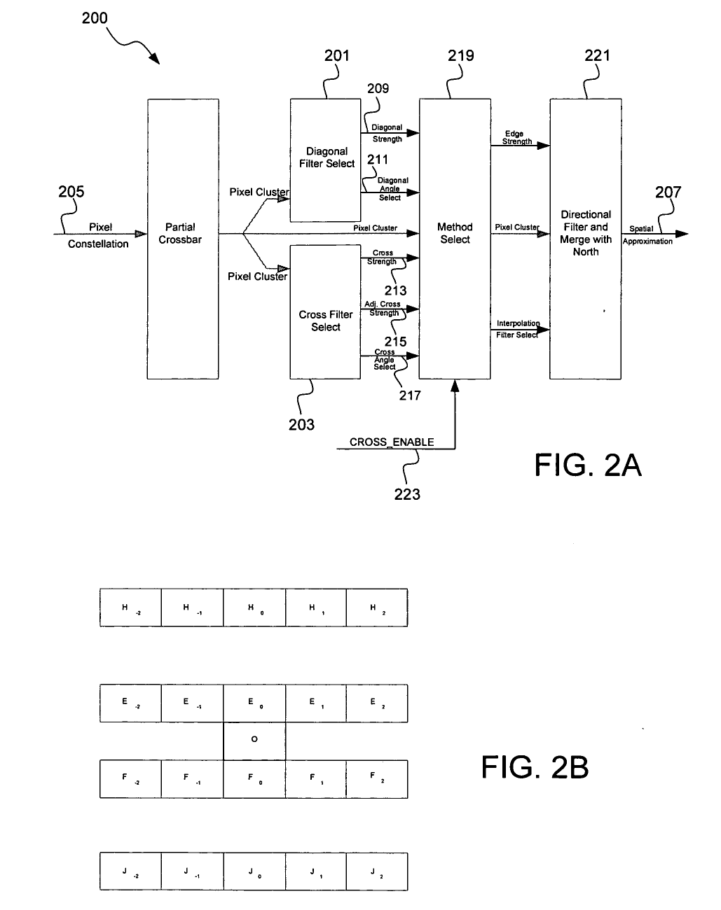

FIG. 2A illustrates a block diagram of an exemplary directional filter 200, in accordance with an embodiment of the present invention. The directional filter 200 may be integrated into a motion adaptive de-interlacer and utilized for motion adaptive deinterlacing with integrated directional filtering. The directional filter 200 may comprise a diagonal filter select 201 and a cross filter select 203. The diagonal filter select 201 may be such as, for example, the diagonal filter described in U.S. patent application Ser. No. 10/945,619, filed Sep. 21, 2004.

The input 205 to the direction filter 200 may be a cluster of pixels, and the output 207 may be a spatial approximation for a missing pixel that the system may be trying to estimate for a missing line in a progressive output frame. The diagonal filter select 201 and the cross filter select 203 may have the cluster of pixels as an input.

The diagonal filter select 201 may output a diagonal strength 209 and a diagonal angle select 211. The outputs 209 and 211 of the diagonal filter select 201 may be utilized to determine whether a diagonal exists and the direction of the diagonal so that an appropriate directional filter may be used. For example, the directional filters may be organized according to 7 directions such as, for example, {NWW, NW, NNW, N, NNE, NE, NEE}, and if none of these directions is selected, it may be determined that the direction of an edge is horizontal.

The cross filter select 203 may output a cross strength 213, an adjusted cross strength 215, and a cross angle select 217, discussed further hereinafter. The outputs of the diagonal filter select 201 and the cross filter select 203 may be input into a method select 219, which may determine which filter may be more appropriate for the edge that is being processed. The cross strength 213 and the adjusted cross edge strength 215 may be compared against the diagonal strength 209 to determine which approximation may be more suitable. When a choice has been made, the prevailing edge strength may be used to control the merge with north (N) to produce a spatial approximation of the current pixel in the directional filter and merge with north block 221.

In an embodiment of the present invention, a control signal such as, for example, the CROSS_ENABLE 223 may be used with the method select 219. The CROSS_ENABLE 223 may be a single programmable register bit. When the CROSS_ENABLE 223 is low, the cross filter select 203 may be disabled and the diagonal filter select 201 may be alone enabled. When the CROSS_ENABLE 223 is high, both the cross filter select 203 and the diagonal filter select 201 may be enabled, and the cross or diagonal selection may be made based on the relative edge strengths, as described hereinafter.

FIG. 2B illustrates an exemplary cluster of pixels, in accordance with an embodiment of the present invention. The cluster of pixels may be, for example, the input 205 of FIG. 2A. The cluster of pixels may be arranged in, for example, a vertical order H, E, F, J from top to bottom, and the current pixel being pixel O, which the system may be trying to estimate. The pixels directly above and below the pixel O with a 0 index are in the same field as the current pixel O. The pixels with the −1 index are also in the same field as the current field but one horizontal location before the current pixel, the ones with the 1 index are also in the same field as the current frame but one horizontal location after the current pixel, and so on. Pixels E and F may be directly above and below pixel O, in the present lines in the interlaced field, and pixels H and J may be the pixels directly above pixel E and below pixel F in present lines in the interlaced field. U.S. patent application Ser. No. 10/945,796, entitled “Pixel Constellation for Motion Detection in Motion Adaptive Deinterlacer” filed Sep. 21, 2004 discloses an exemplary pixel constellation that may be utilized in connection with the present invention for pixels H, E, F, and J. Accordingly, U.S. Provisional Patent Application Ser. No. 10/945,796, filed Sep. 21, 2004 is hereby incorporated herein by reference in its entirety.

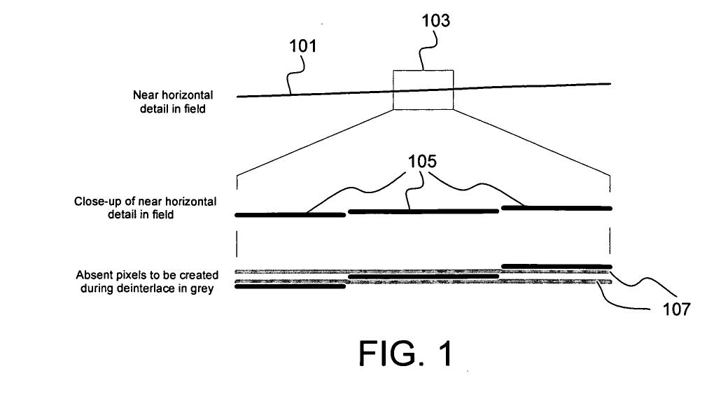

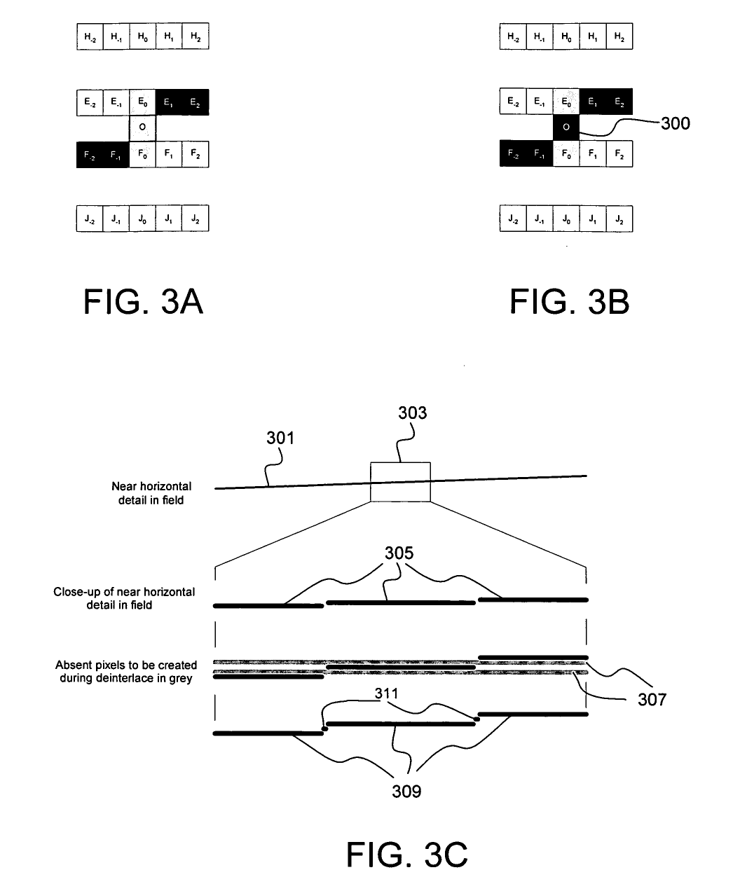

FIG. 3A illustrates an exemplary cluster of pixels in a near horizontal thin line in a field. The cluster of pixels may be, for example, the edges of two segments 105 of the near horizontal thin line 101 of FIG. 1. A little intensity of the dark object (the line) may escape into pixels E₀ and F₀ during pixelization and interlacing processes.

FIG. 3B illustrates an exemplary cluster of pixels in a near horizontal thin line in a field when deinterlaced appropriately to maintain continuity of the line, in accordance with an embodiment of the present invention. The pixel O may be estimated using the pixels above it and below it, which is effectively a north filter, as follows:

$$O = \frac{( - 3 {H}_{0} + 35 {E}_{0} + 35 {F}_{0} - 3 {J}_{0} )}{64} \qquad ( 1 )$$

The north filter only uses pixels directly above and below the pixel, which in this case may not be part of the edges of the horizontal segments, and the pixel O may look like a gap between the segments. Alternatively, pixel O may be estimated using the pixels to its left and right from the present lines above and below, which is effectively an east/west filter, as follows:

$$O = \frac{( {E}_{- 1} + {E}_{1} + {F}_{- 1} + {F}_{1} )}{4} \qquad ( 2 )$$

The east/west filter may provide better results than the north filter since it uses pixels from the edges, which may yield a “darker” pixel O. However, the value of the pixel may still be too “light” to create continuity between the segments of the line. Yet another alternative way may be to use only the pixels of the edges of the segments above and below pixel O, which is effectively a north-east filter in this case, as follows:

$$O = \frac{( {E}_{1} + {F}_{- 1} )}{2} \qquad ( 3 )$$

Pixel O 300 may be the result of applying a northeast filter to the pixels at the edges of the horizontal segments of the near horizontal thin line. While the equation above uses two pixels, one from each segment, different combinations of pixels may be utilized to estimate the pixel O.

Applying the northeast filter may yield a pixel O that is as dark as the horizontal segments themselves, and such may be done for all the segments of the near horizontal thin line, thus creating a continuity in the deinterlaced line. FIG. 3C illustrates an exemplary result of applying a northeast filter to a near horizontal thin line, in accordance with an embodiment of the present invention. The line 301 may be a near horizontal line such as, for example, the near horizontal line 101 of FIG. 1. On limiting visibility to a small horizontal window 303, when an image is quantized into pixels and viewed close-up, near horizontal lines such as line 301 break into a collection of horizontal segments. Looking closer at a piece 303 of the line 301, the piece 303 may comprise horizontal segments 305. The missing lines from the field such as lines 307 may be generated by the deinterlacer. A deinterlacer may treat each of the segments 305 as a horizontal line and reproduce the line 301 as a collection of horizontal segments. In an embodiment of the present invention, a northeast filter such as, for example, the one described by equation (3) above, may be applied to the horizontal segments 305, to yield an output 309, which may appear continuous due to adding pixels 311, thus reproducing the near horizontal line without any or minimal segmentation.

In an embodiment of the present invention, a diagonal filter such as the one described in U.S. patent application Ser. No. 10/945,619, filed Sep. 21, 2004, may not detect near horizontal lines as a strong indication to filter in the northeast direction; a filter in the northerly direction may predominate, since to the diagonal filter the near horizontal line may be detected as a horizontal line. In an embodiment of the present invention, a cross detector and filter may identify the segment boundaries and filter in the northeast or northwest direction, as appropriate.

A matrix P may represent the cluster of pixels as follows:

$$Top$$

$$\begin{matrix}Vertical \\ Lines\end{matrix} \begin{matrix}↓ & P = {[ \begin{matrix}{H}_{- 2} & {H}_{- 1} & {H}_{0} & {H}_{1} & {H}_{2} \\ {E}_{- 2} & {E}_{- 1} & {E}_{0} & {E}_{1} & {E}_{2} \\ {F}_{- 2} & {F}_{- 1} & {F}_{0} & {F}_{1} & {F}_{2} \\ {J}_{- 2} & {J}_{- 1} & {J}_{0} & {J}_{1} & {J}_{2}\end{matrix} ]}_{{⟶}_{{}_{Left} Horizontal {Pixels}_{Right}}}\end{matrix}$$

$$Bottom$$

A cross detector may be used to determine the strength of the match between horizontal segments of the same line that may not be on the same level, hence indicating the presence of a near horizontal line. The cross detector may be represented with a matrix f_{cross}, where:

$${f}_{cross} = [ \begin{matrix}0 & 0 & 0 & 0 & 0 \\ 0.25 & 0.25 & 0 & - 0.25 & - 0.25 \\ - 0.25 & - 0.25 & 0 & 0.25 & 0.25 \\ 0 & 0 & 0 & 0 & 0\end{matrix} ]$$

The strength of the match d_cross may be given by:
d_cross={(4×abs(f_{cross}P^{T})×CROSS_GAIN)+64}>>7

The strength of the match may give a strong reading when there is a significant difference between a top left to bottom right and a bottom left to top right pattern. If a strong reading is found, it may then be necessary to determine which of the two directions, from a larger perspective, is correct. Using the pixel pattern of FIG. 3A as an example, determining which direction is correct may amount to determining whether what is present is intended to be a black line from bottom left to top right, or a white line from top left to bottom right. Once determined, a filter northeast or northwest will result in the absent pixel approximation for O being black or white, respectively.

From a global view of the image, especially for a human, it may be quite easy to determine the direction of significance of horizontal segments. For reasonable hardware cost, the view available during pixel generation may be necessarily narrower. Determining whether a top left to bottom right or bottom left to top right approximation is appropriate may require an assumption that in general, it is detail that is the more important to maintain, so pixel O is to be chosen such that it is detail rather than background that is contiguous. For example, if the image that is being treated is an image of a power line against the sky, the pixels between each horizontal segment may be chosen to be closer to the luminance of the power line (detail) rather than the luminance of the sky (background).

In an embodiment of the present invention, a simple segmentation may be performed to determine which pixels in the cluster are detail and which are background.

$${avg}_{cross} = [ \begin{matrix}0 & 0 & 0 & 0 & 0 \\ 0 & 0.25 & 0 & 0.25 & 0 \\ 0 & 0.25 & 0 & 0.25 & 0 \\ 0 & 0 & 0 & 0 & 0\end{matrix} ]$$

A threshold may be first calculated:
thresh=avg_{cross}P^{T}

Then each pixel in the cluster may be compared against this threshold. The pixels may be segmented into two sets: those above the threshold and those at or below the threshold. Above_thresh_count may be defined to be equal to the number of pixels in the cluster with luminance greater than the threshold. This may imply that there will be (20—above_thresh_count) pixels that are in the other set. It may be assumed that the detail (e.g. power line) is the set with the fewer number of members; the background (e.g. the sky) has the greater number. Determining which set a particular cross direction is a member of may allow a decision of which interpolation filter direction is to be selected, as shown in the following pseudo code:

if above_thresh_count == 10 then

//Ambiguous.
Select Int_{cross}

$else if \frac{{E}_{- 1} + {F}_{1}}{2} > thresh then$

if above_thresh_count > 10 then

Select Int_{NE}

else

Select Int_{NW}

else

if above_thresh_count > 10 then

Select Int_{NW}

else

Select Int_{NE}

The interpolation may be as follows:

$${CrossInt}_{NE} = [ \begin{matrix}0 & 0 & 0 & 0 & 0 \\ 0 & 0 & 0 & 0.5 & 0 \\ 0 & 0.5 & 0 & 0 & 0 \\ 0 & 0 & 0 & 0 & 0\end{matrix} ]$$

$${CrossInt}_{NW} = [ \begin{matrix}0 & 0 & 0 & 0 & 0 \\ 0 & 0.5 & 0 & 0 & 0 \\ 0 & 0 & 0 & 0.5 & 0 \\ 0 & 0 & 0 & 0 & 0\end{matrix} ]$$

$${CrossInt}_{cross} = [ \begin{matrix}0 & 0 & 0 & 0 & 0 \\ 0 & 0.25 & 0 & 0.25 & 0 \\ 0 & 0.25 & 0 & 0.25 & 0 \\ 0 & 0 & 0 & 0 & 0\end{matrix} ]$$

The northeast and northwest filters may be the same as the filters used in the diagonal filter. The cross interpolator may be the same as the filter used to produce the cross average for segmentation, shown above.

Once an interpolator has been chosen, a back-off mechanism may be provided to ensure that the chosen direction fits with the actual presence of a boundary between two segments. Without such a mechanism, certain edges may incorrectly trigger the cross detection and “hanging dots” may appear at the output.

If, for example, interpolation in the northeast direction is chosen, it may be reasonably expected that pixels E₁ and F₋₁ are from the same object and likely have similar luminance. The value X_diff may be computed and used to determine the value of the adjusted cross “edge strength,” d_cross_adj. X_diff may be small when the pixels in the interpolation direction are similar, and may be computed as follows:

$$X\_diff = ABS ( \{ \begin{matrix}0 & when {CrossInt}_{cross} & selected \\ \frac{{E}_{1} - {F}_{- 1}}{2} & when {CrossInt}_{NE} & selected \\ \frac{{E}_{- 1} - {F}_{1}}{2} & when {CrossInt}_{NW} & selected\end{matrix} )$$

Using X_diff, d_cross_adj may be calculated as follows:
d_cross_adj=CROSS_ADJ_GAIN×(d_cross−X_diff)

Referring back to FIG. 2A, the diagonal filter interpolated approximation for the pixel (Diag), may be calculated by the diagonal filter select block 201 in parallel with the cross interpolated approximation (Cross) calculated by the cross filter select block 203. With the subscripts x simply being placeholders for the specific directions chosen the values for Diag and Cross may be computed as follows:
Diag=Intₓ×P^{T}
Cross=CrossIntₓ×P^{T}

When the pixel approximation and the corresponding edge strength have been selected. The edge strength may control the merge between the angled and the north approximations using the generalized blend. The luma spatial approximation of an absent pixel, Sₐ may then be computed as follows:
X=Int_{N}×P^{T}
Y=pix_approx
Z=Y−X
M=d_final
M_{L}=MAX{MIN [symbol] M, Z,−M}
Sₐ=Out=X+M_{L}

Where pix_approx and d_final may be determined with the following pseudo-code:

if (CROSS_ENABLE && d_cross > CROSS_THRESH &&
d_cross_adj > d) then

//Use cross filter.
d_final = d_cross_adj
pix_approx = Cross

else

//Use diagonal filter.
d_final = d
pix_approx = Diag

where d is the diagonal strength such as, for example, the diagonal strength 209 of FIG. 2A.

Referring again to FIG. 2A, the decision process between diagonal and cross filter directions may occur ahead of the actual directional interpolation. The decision process may be done in the method select block 219. Doing so may reduce some duplication of calculations.

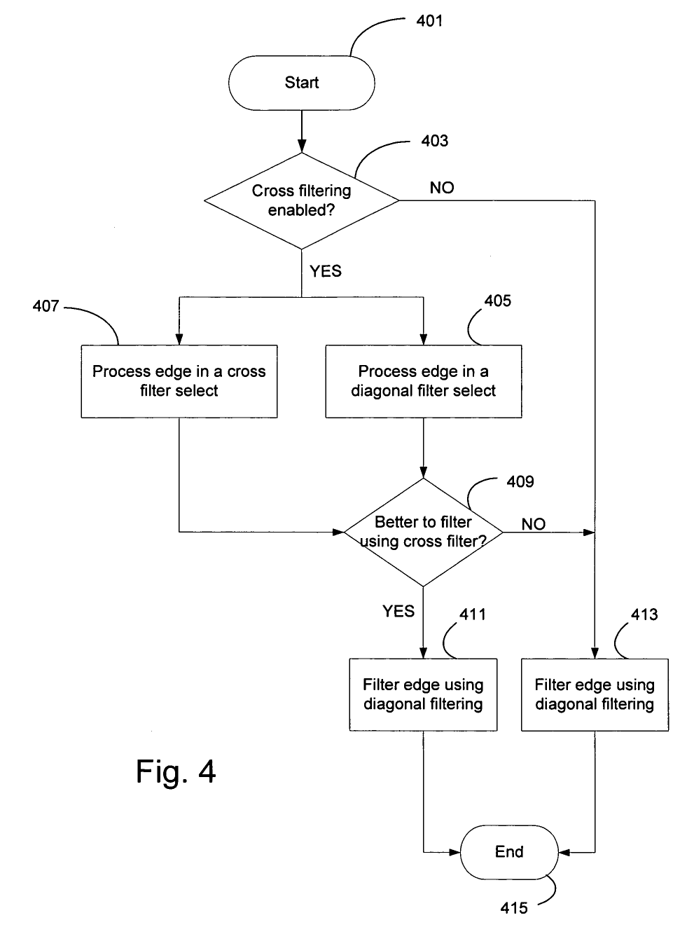

FIG. 4 illustrates a flow diagram of an exemplary method for detecting near horizontal lines, in accordance with an embodiment of the present invention. The method may start at a starting block 401 where an edge may be identified, and at a next block 403 it may be determined whether cross filtering is enabled or disabled. If the cross filtering is disable, the edge may be filtered using diagonal filtering at a next block 413, and a spatial approximation for the edge to be used in processing the video data may be output at an end block 415.

If the cross filtering is enable, the edge may be processed by two different blocks such as, for example, a diagonal filter select block 201 and a cross filter select block 203 of FIG. 2A. At a block 405, the edge may be processed in a diagonal filter edge select block to determine the edge's diagonal strength and its diagonal angle select. Additionally, at a block 407, the edge may be processed in a cross filter edge select block to determine the edge's cross strength, its adjusted cross strength and its cross angle select. The result from both block 405 and block 407 may then be used at a next block 409 to determine whether to filter the edge using a diagonal filter or a cross filter. If it is determined that diagonal filtering may be more appropriate, the edge may be filtered using diagonal filtering, in the direction indicated by the diagonal filter, at a next block 413, and a spatial approximation for the edge to be used in processing the video data may be output at an end block 415. If it is determined that cross filtering may be more appropriate, the edge may be filtered using diagonal filtering, in the direction indicated by the cross filter, at a next block 411, and a spatial approximation for the edge to be used in processing the video data may be output at an end block 415.

In an embodiment of the present invention, the method of the flow diagram of FIG. 4 may be performed utilizing a filtering system such as, for example, the directional filter of FIG. 2A. The filtering system may be a portion of a system such as, for example, a motion adaptive deinterlacing system.

Accordingly, the present invention may be realized in hardware, software, or a combination thereof. The present invention may be realized in a centralized fashion in at least one computer system, or in a distributed fashion where different elements may be spread across several interconnected computer systems. Any kind of computer system or other apparatus adapted for carrying out the methods described herein may be suited. A typical combination of hardware and software may be a general-purpose computer system with a computer program that, when being loaded and executed, may control the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system that detects edges that are near horizontal thin lines in interlaced video in a deinterlacer, the system comprising:
a first processing circuitry that assesses an edge in a diagonal direction;
a second processing circuitry that assesses the edge in a near horizontal direction; and
a third processing circuitry that filters the edge in the diagonal direction or the near horizontal direction to use in deinterlacing the edge based on assessment results.

2. The system according to claim 1 wherein the first processing circuitry comprises:
a first circuitry that determines the angle associated with the edge; and
a second circuitry that determines the strength associated with the edge.

3. The system according to claim 1 wherein the second processing circuitry comprises:
a first circuitry that determines the angle associated with the edge;
a second circuitry that determines the strength associated with the edge; and
a third circuitry that determines an adjusted strength associated with the edge.

4. The system according to claim 3 wherein the first circuitry comprises:
at least one processor capable of examining a set of pixels associated with the edge;
the at least one processor capable of determining a first subset of pixels that comprise the edge; and
the at least one processor capable of determining a second subset of pixels that comprise a background with respect to the edge.

5. The system according to claim 1 wherein the first processing circuitry determines the direction of the edge and selects an associated set of filter coefficients.

6. The system according to claim 1 wherein the second processing circuitry determines the direction of the edge and selects an associated set of filter coefficients.

7. The system according to claim 1 wherein the third processing circuitry comprises a control signal.

8. The system according to claim 7 wherein the second processing circuitry is disabled when the control signal is low.

9. The system according to claim 7 wherein the second processing circuitry is enabled when the control signal is high.

10. A method that detects edges that are near horizontal thin lines in interlaced video in a deinterlacer, the method comprising:
assessing an edge in a diagonal direction;
assessing the edge in a near horizontal direction; and
filtering the edge in the diagonal direction or the near horizontal direction to use in deinterlacing the edge based on assessment results.

11. The method according to claim 10 wherein the assessing of the edge in the diagonal direction comprises:
determining the angle associated with the edge; and
determining the strength associated with the edge.

12. The method according to claim 10 wherein the assessing of the edge in the near horizontal direction comprises:
determining the angle associated with the edge;
determining the strength associated with the edge; and
determining an adjusted strength associated with the edge.

13. The method according to claim 12 wherein determining the angle associated with the edge comprises:
examining a set of pixels associated with the edge;
determining a first subset of pixels that comprise the edge; and
determining a second subset of pixels that comprise a background with respect to the edge.

14. The method according to claim 10 wherein assessing the edge in the diagonal direction comprises determining the direction of the edge and selecting an associated set of filter coefficients.

15. The method according to claim 10 wherein assessing the edge in the near horizontal direction comprises determining the direction of the edge and selecting an associated set of filter coefficients.

16. The method according to claim 10 further comprising utilizing a control signal.

17. The method according to claim 16 wherein assessing the edge in the near horizontal direction is disabled when the control signal is low.

18. The method according to claim 16 wherein assessing the edge in the near horizontal direction is enabled when the control signal is high.

19. A machine-readable storage having stored thereon, a computer program having at least one code section that detects edges that are near horizontal thin lines in interlaced video in a deinterlacer, the at least one code section being executable by a machine for causing the machine to perform steps comprising:
assessing an edge in a diagonal direction;
assessing the edge in a near horizontal direction; and
filtering the edge in the diagonal direction or the near horizontal direction to use in deinterlacing the edge based on assessment results.

20. The machine-readable storage according to claim 19 wherein the code for assessing of the edge in the diagonal direction comprises:
code for determining the angle associated with the edge; and
code for determining the strength associated with the edge.

21. The machine-readable storage according to claim 19 wherein the code for assessing of the edge in the near horizontal direction comprises:
code for determining the angle associated with the edge;
code for determining the strength associated with the edge; and
code for determining an adjusted strength associated with the edge.

22. The machine-readable storage according to claim 21 wherein the code for determining the angle associated with the edge comprises:
code for examining a set of pixels associated with the edge;
code for determining a first subset of pixels that comprise the edge; and
code for determining a second subset of pixels that comprise a background with respect to the edge.

23. The machine-readable storage according to claim 19 wherein the code for assessing the edge in the diagonal direction comprises code for determining the direction of the edge and selecting an associated set of filter coefficients.

24. The machine-readable storage according to claim 19 wherein the code for assessing the edge in the near horizontal direction comprises code for determining the direction of the edge and selecting an associated set of filter coefficients.

25. The machine-readable storage according to claim 19 further comprising code for utilizing a control signal.

26. The machine-readable storage according to claim 25 wherein the code for assessing the edge in the near horizontal direction is disabled when the control signal is low.

27. The machine-readable storage according to claim 25 wherein the code for assessing the edge in the near horizontal direction is enabled when the control signal is high.
